(19) United States
(12) Patent Application Publication
(10) Pub. No.: US 2020/0314956 A1
(43) Pub. Date: Oct. 1, 2020

(54) METHODS AND APPARATUSES FOR NETWORK ONBOARDING

(71) Applicant: SONY CORPORATION, Tokyo (JP)

(72) Inventors: David BERTHET, Åkarp (SE); Kåre AGARDH, Rydebäck (SE)

(21) Appl. No.: 16/826,038

(22) Filed: Mar. 20, 2020

(30) Foreign Application Priority Data
Apr. 1, 2019 (SE) 1950399-4

(51) Int. Cl. H04W 84/18; H04W 48/16; H04W 8/00; H04W 52/02; H04W 24/02; H04L 5/00

(52) U.S. Cl. CPC H04W 84/18; H04W 48/16; H04W 8/005; H04L 5/0055; H04W 52/0219; H04W 24/02; H04W 52/0216

(57) ABSTRACT

A wireless electronic device is operable for network onboarding in a system having a server and a plurality of network nodes connected on a network to the server. The device operates its transceiver at one or more predefined association frequencies for receipt of a node beacon from any network node among the network nodes, the node beacon including communication parameter data for the originating network node. The device further operates its transceiver, when configured in accordance with the communication parameter data, to transmit an onboarding request for the server, to be received and forwarded by the network node. To the extent that the server receives onboarding requests from the device via more than one network node, the server appoints one of the network nodes for the device and informs the appointed network node, whereby the device is onboarded.

### RELATED APPLICATION DATA

This application claims the benefit of Swedish Patent Application No. 1950399-4, filed Apr. 1, 2019, the disclosure of which is incorporated herein by reference in its entirety

### TECHNICAL FIELD

The present disclosure generally relates to wireless networking and in particular to a technique for network onboarding of wireless devices in a wireless network system.

### BACKGROUND

Generally, a wireless network system may be seen to comprise a plurality of wireless end devices, a plurality of gateways, hosts or access points, and one or more servers, where the end devices are arranged to transmit data to and/or receive data from the one or more servers by communication with the gateways. In such a wireless network system, communication is wireless at least between the end devices and the gateways.

Network onboarding is a generic term that refers to the process by which a device gains access to a network for the first time. Depending on context, this process may also be denoted “association”, “pairing”, etc. Network onboarding of end devices and definition of data routing in a wireless network system are important phases during installation and setup of the wireless network system.

Many countries have regulatory requirements for wireless transmissions (radio transmissions). While the regulatory requirements may be harmonized in Europe, there are significant differences between countries in other parts of the world and between countries on different continents. For example, a wireless device configured for Europe may typically not be used in the United States or in countries in Asia. Differences in regulatory requirements may relate to the available radio frequency bands, the allowable output power levels and the available type of radio modulation. This means that the device manufacturer needs to ensure that the wireless devices are configured in compliance with the differing regulatory requirements. Further, device manufacturers may be required to limit the ability of customers or end users to manipulate the wireless devices to operate outside of local regulations and restrictions. Thus, to comply with local regulatory requirements, device manufacturers may pre-configure the wireless devices based on the regulatory domain and/or country of destination. To accommodate this, device manufacturers may need to define different stock keeping units (SKUs) for each regulatory domain and/or country, which leads to increased production cost and delivery time.

Wireless network systems are commonly used in the field of machine-to-machine (M2M) communication, i.e. communication between machines without human intervention. M2M systems are e.g. implemented for collection of sensor data from sensors that are integrated with or connected to wireless end devices. M2M systems typically include a large number of end devices, and it is thus desirable to minimize the need for manual labor when installing the end devices in the M2M system, including network onboarding and definition of data routing. In many cases, the end devices in M2M systems are battery powered with resulting limitations on power consumption.

U.S. Pat. No. 9,763,173 proposes a universal access point that implements an automatic configuration approach, in which the access point obtains and applies regulatory domain and country configuration from other access points or from a central server based on the current location of the access point, e.g. given by a GPS in the access point or a connected device.

### SUMMARY

It is an objective of the present disclosure to devise a solution that at least partly overcomes one or more limitations of the prior art.

Another objective is to facilitate installation and life cycle of wireless end devices in a network system.

Yet another objective is to enable the wireless end devices to be generic with respect to regulatory requirements in different regions.

A further objective is to enable automatic regional configuration of such a generic end device during its installation in the network system.

A still further objective is to restrict the power consumption of the end device during its installation in the network system.

One or more of these objectives, as well as further objectives that may appear from the description below, are at least partly achieved by an electronic device, a network node, and a server according to the independent claims, embodiments thereof being defined by the dependent claims.

Still other objectives, as well as features, aspects and technical effects will appear from the following detailed description, from the attached claims as well as from the drawings.

### BRIEF DESCRIPTION OF DRAWINGS

Embodiments will now be described in more detail with reference to the accompanying schematic and exemplifying drawings.

FIG. 1 illustrates a communication system including a server, network nodes and an electronic device.

FIGS. 2A-2C are block diagrams of an electronic device, a network node and a server, respectively.

FIGS. 3A-3C are flow charts of methods performed in an electronic device, a network node and a server, respectively, for network onboarding of the electronic device.

FIG. 4 is a sequence diagram of operations in the system of FIG. 1 for network onboarding of the electronic device.

FIGS. 5A-5D correspond to FIG. 1 and illustrate communication in the system for network onboarding of the electronic device.

FIGS. 6A-6D are flow charts of processes that may be performed by the respective network node in FIG. 1.

FIG. 7 is a flow chart of a process for network onboarding that may be performed by the electronic device in FIG. 1.

### DETAILED DESCRIPTION OF EXAMPLE EMBODIMENTS

Embodiments will now be described more fully hereinafter with reference to the accompanying drawings, in which some, but not all, embodiments are shown. Indeed, the subject of the present disclosure may be embodied in many different forms and should not be construed as limited to the embodiments set forth herein; rather, these embodiments are provided so that this disclosure may satisfy applicable legal requirements. Like numbers refer to like elements throughout.

Also, it will be understood that, where possible, any of the advantages, features, functions, devices, and/or operational aspects of any of the embodiments described and/or contemplated herein may be included in any of the other embodiments described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more”, even though the phrase “one or more” or “at least one” is also used herein. As used herein, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments. As used herein, a “set” of items is intended to imply a provision of one or more items.

It will furthermore be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing the scope of the present disclosure. As used herein, the term “and/or” includes any and all combinations of one or more of the associated listed items.

Embodiments relate to installation and setup of wireless networks, and in particular to onboarding and data routing, which involves determining how data is to be transferred and acknowledged from end devices via network nodes to a central server, e.g. a cloud server. Embodiments are applicable to M2M communication, e.g. in wireless sensor networks.

Embodiments may provide flexible and dynamic network configuration, while also providing enabling functionality to support efficient regulatory domain handling. As explained in the Background section, the regulatory requirements for radio transmissions differ between geographic domains, such as different continents or different countries on a continent, e.g. with respect to the available radio frequency bands, the output power levels and the types of radio modulation.

Embodiments described in the following provide an adaptive network configuration technique that ensures that regulatory requirements in all global regions are fulfilled while also allowing installation flexibility. Thereby, the embodiments enable the end devices to be generic with respect to regulatory requirements, in that they may be automatically configured and become operational in compliance with regional regulatory requirements when they are first installed in a supporting network system. Embodiments also enable renewed automatic onboarding if the end device loses its wireless connection to the network. Also, embodiments enable the end devices to be similarly automatically configured if they are moved to another region with different regulatory requirements.

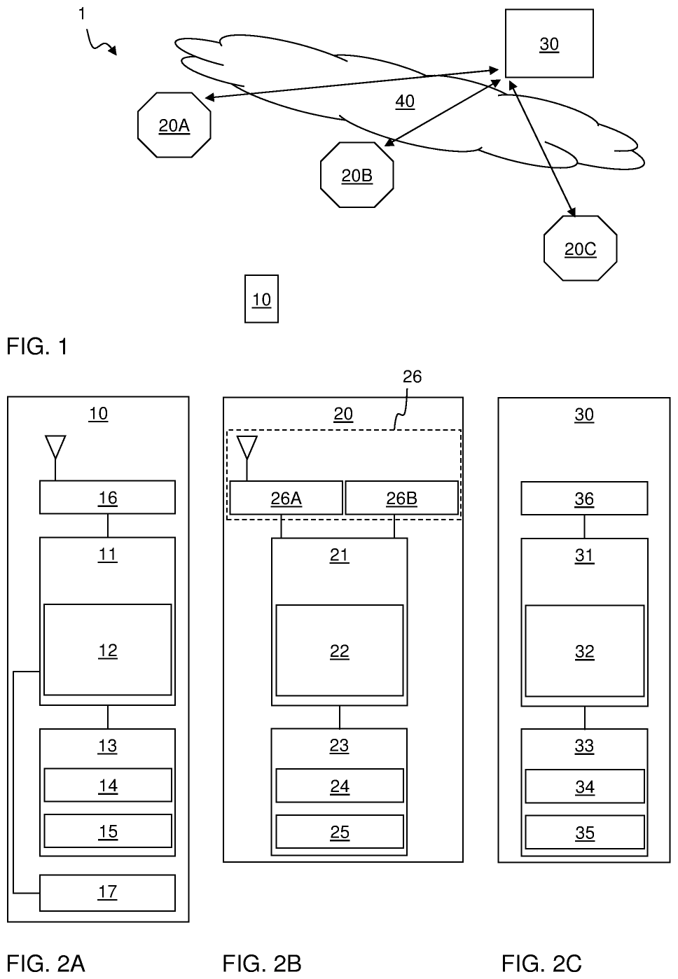

FIG. 1 shows a schematic example of a network system 1 that comprises a plurality of wireless end devices 10 (one shown), a plurality of network access nodes 20A-20C and a central server 30. The wireless end device 10 (denoted ED in the following) is an electronic device 10 which is configured to be onboarded on the network system 1 to wirelessly transmit data to one of the nodes 20A-20C for transmission to the central server 30 over a network 40. In the following examples, the system 1 is a wireless sensor network and the respective ED 10 comprises or is connected to a sensor and is configured to transmit sensor data to the central server 30, which is thus arranged to gather the sensor data from the EDs 10 in the system 1. A wireless sensor network typically includes a large number of EDs and a smaller number of nodes 20A-20C. The network 40 may be any type of wired and/or wireless data communication network and may be based on any networking architecture, e.g. including one or more LANs and/or one or more WANs, such as the Internet. The nodes 20A-20C are configured to operate as gateways, access points or hosts for the respective ED 10 and are denoted “gateways” in the following. The respective gateway 20A-20C is installed in the network 40 and configured for direct wireless communication with the respective ED 10 in compliance with the local regulatory requirements for radio transmissions. The wireless communication between ED 10 and gateway 20A-20C may be based on any type of wireless communication protocol, standardized or non-standardized, using any type of radio access technology and in any allowed and available radio frequency spectrum, be it licensed or unlicensed. The wireless communication typically has a limited range, e.g., less than about 100-500 m.

The system 1 enables onboarding of the ED 10 by a novel methodology which is exemplified in the following and presumes that the gateways 20A-20C have been configured and connected to the network 40 at a respective installation site. Communication parameters of the respective gateway 20A-20C have been set, e.g. by use of geolocation and look-up tables, as known in the art, or by remote or manual (local) configuration. The communication parameters may include radio and protocol parameters suitable for the respective installation site. The respective gateway 20A-20C is operable in, and switchable between, an association mode and a normal mode (operational mode). The communication parameters comprise a least one set of parameters per regulatory region or frequency band for the respective mode, including one or more association frequencies for the association mode and one or more communication frequencies for the normal mode. The following description also presumes that a root of trust has been established in the system 1, e.g. by use of integrity mechanisms, to secure the integrity of data that is transmitted between components of the system 1.

After power on and configuration, the respective gateway 20A-20C periodically transmits a discovery frame (“beacon”) in accordance with the communication parameters for the association mode in its present region, e.g. on the one or more association frequencies. The discovery frame includes one or more parameter fields that define communication parameter data of the originating gateway 20A-20C. The communication parameter data represent the normal mode of the gateway 20A-20C and may for example include radio transmission parameters such as communication frequency, modulation, and coding, or timing-related information. The gateways 20A-20C may use identical or different communication parameter data.

The EDs 10 are configured to store static definition data. In the following examples, the static definition data comprises a set of association frequencies used by the gateways 20A-20C in the system 1, and may further define output power level, modulation, coding, etc. for the respective association frequency. The EDs 10 may also store regulatory data representative of the regulatory requirements for radio transmissions in all relevant regions. When powered on, the respective ED 10 is unaware of its present regulatory domain and therefore performs an initial discovery procedure by periodically listening for beacons in accordance with the static definition data, e.g. on the set of association frequencies. Upon receipt of a beacon, the ED 10 transmits a request frame (“onboarding request”) in accordance with the communication parameter data in the beacon, e.g. on a specific communication frequency. The onboarding request may be received by all gateways 20A-20C that are located within range of the ED 10 and operate in the normal mode and in accordance with the communication parameter data. If the gateways 20A-20C are assigned individual (different) communication parameter data, the respective ED 10 may transmit an onboarding request for the respective gateway 20A-20C using the communication parameter data contained in the beacon from the respective gateway 20A-20C.

Upon receipt of an onboarding request, the respective gateway 20A-20C forwards the onboarding request to the server 30 over the network 40. Based on predefined rules, policies or explicit configuration, the server 30 appoints one of the gateways 20A-20C to be associated with the ED 10 and informs the appointed gateway that the ED 10 is onboarded. Thereby, the onboarding of the ED 10 by the server 30 is completed. Upon receipt of an acknowledgement from the appointed gateway confirming that the ED 10 is onboarded, the ED 10 adopts the communication parameter data of the appointed gateway and is thereby operable in the network 40 to transmit data to the server 30 via the appointed gateway.

It is realized that the EDs 10 may be generic so as to be deployable in all regions irrespective of the local regulatory requirements for radio transmissions. This is achieved, inter alia, by configuring the EDs 10 to store and use the static definition data for beacon detection, and by configuring the gateways to transmit, in accordance with communication parameters that are compliant with the static definition data, beacons including communication parameter data for the respective gateway. Despite the generic nature of the EDs 10, the regional configuration and onboarding of the EDs 10 is simple and may be automated and performed without human intervention. To further minimize human intervention, the EDs 10 may be configured to repeat the initial discovery procedure after each power cycle. In other words, the network configuration of the ED 10 may be lost whenever the ED 10 is powered off. Similarly, the EDs 10 may be configured to repeat the initial discovery procedure whenever they determine that they are out of range of the appointed gateway.

In the examples herein, onboarding is exclusive, meaning that the respective ED 10 may only be connected to one network at a time. However, once the ED 10 is detached from one network, the ED 10 will seek to attach to this or another network. Thus, EDs 10 onboarded on a first network may detach from the first network and re-initiate the initial discovery procedure to onboard on a second network, which may be different from the first network. The EDs 10 may actively detach from the first network or may be detached by being powered down or moved out of range. For example, an ED 10 that has been onboarded and operative in a first region will, if shipped to a second region, automatically onboard any existing network in the second region, which may or may not belong the same regulatory region as the first region.

The initial discovery procedure ensures power efficient operation of the ED 10 which, for onboarding, only needs to intermittently listen, in accordance with the static definition data, for beacons transmitted by gateways, and, upon receipt of a beacon, transmit the onboarding request in accordance with the communication parameter data. Thus, the initial discovery procedure is suitable for battery-powered EDs. Typically, a limited number of association frequencies are defined in the static definition data, since the power consumption scales with the association frequencies to be scanned by the ED 10.

Another characteristic of the above-described example embodiment is that the onboarding of the EDs 10 and the appointment of gateways 20A-20C to EDs 10 is decided and controlled by the server 30. Thus, the ED 10 need not be preconfigured for connection to a particular gateway and the server 30 may appoint the gateways based on any suitable criterion. Thereby, the amount of persistently stored information in the EDs 10 may be minimized and the coordination of the onboarding process may be fully controlled by the server 30. This also implies that the gateways 20A-20C need not implement any coordination functionality but may merely relay (forward) data between EDs 10 and server 30, and possibly perform dedicated actions when instructed by the server 30, e.g. to transmit an acknowledgement message to a specific ED.

Before explaining embodiments in more detail, structures of the ED 10, the gateway 20 and the server 30 will be exemplified with reference to the block diagrams in FIGS. 2A-2C.

The ED 10 of FIG. 2A includes a control circuit 11 responsible for the overall operation of the ED 10. In the illustrated example, the control circuit 11 includes a processing device or processor 12, which may be a central processing unit (CPU), microcontroller, microprocessor, ASIC, FPGA, or any other specific or general processing device. The processor 12 may execute instructions 14 stored in a separate memory, such as memory 13, in order to control the operation of the ED 10. The instructions 14 when executed by the processor 12 may cause the ED 10 to perform any of the related methods described herein. As indicated in FIG. 2A, the memory 13 may also store data 15 for use by the processor 12. The data 15 may include the static definition data and the regulatory data mentioned above. The memory 13 may be, for example, one or more of a buffer, a flash memory, a hard drive, a removable media, a volatile memory, a non-volatile memory, a random access memory (RAM), or another suitable device. In a typical arrangement, the memory 13 includes a non-volatile memory for long term data storage and a volatile memory that functions as system memory for the control circuit 11. The memory 13 may exchange data with the control circuit 11 over a data bus. Accompanying control lines and an address bus between the memory 13 and the control circuit 11 also may be present. The memory 13 is considered a non-transitory computer readable medium. It is also conceivable that all or part of the instructions 14 and/or the data 15 is stored in a memory (not shown) within the control circuit 11. The ED 10 further includes a radio circuit 16 for wireless communication. The radio circuit 16 may comprise at least one radio transceiver, at least one antenna, tuners, impedance matching circuits, and any other components needed for wireless communication in a set of supported frequency bands. In the illustrated example, the ED 10 further comprises a sensor device 17, which may be of any conceivable type and sense any conceivable parameter, including but not limited to pressure, heartbeat, temperature, humidity, moisture, light, luminosity, altitude, vibration, sound, acceleration, speed, position, flow rate, concentration, electric current, electric resistance, electric voltage, electric power, frequency, etc. Although not shown in FIG. 2A, the ED 10 also includes a power source, e.g. a battery, and may include further components such as an MMI (man-machine interface), one or more I/O interfaces, etc.

The gateway 20 of FIG. 2B comprises a control circuit 21 that includes a processing device or processor 22, and a memory 23 for storing instructions 24 which, when executed by the processor 22, may cause the gateway 20 to perform any of the related methods described herein. The foregoing description of corresponding components of the ED 10 is equally applicable to the gateway 20 and will not be repeated. As indicated, data 25 for use by the processor 12 may also be stored in the memory 23. All or part of the data 25 may alternatively be stored in another memory, e.g. an external memory (not shown). The data 25 may include a regulatory domain definition and radio configuration data. The radio configuration data defines one or more association frequencies and one or more communication frequencies, and may also define output power level, modulation, coding, etc. for the respective frequency. The gateway 20 comprises a communication device 26, which includes a radio circuit (“first transceiver”) 26A for wireless communication with EDs. The radio circuit 26A may thus be configured in correspondence with the radio circuit 16 in the ED 10. The communication device 26 comprises a network communication circuit (“second transceiver”) 26B, which is configured for connection to and communication on the network 40 in accordance with any suitable communication protocol.

The server 30 of FIG. 2C may be implemented on a single machine or may employ computer system resources of a plurality of machines, e.g. by so-called cloud computing. Irrespective of implementation, the server 30 may be generally represented to comprise a control circuit 31 with a processing device or processor 32, and a memory 33 for storing instructions 34 which, when executed by the processor 32, may cause the server 30 to perform any of the related methods described herein. The foregoing description of corresponding components of the ED 10 is equally applicable to the server 30 and will not be repeated. As indicated, data 35 for use by the processor 32 may also be stored in the memory 33. All or part of the data 35 may alternatively be stored in another memory, e.g. an external memory (not shown). The data 35 may include the current logical network topology, including the association between gateways and EDs, the current physical network topology, including the geographic location of the gateways, and sensor data received from EDs in the system. The server 30 comprises a network communication device 36, which is configured for connection to and communication on the network 40 in accordance with any suitable communication protocol.

The instructions 14, 24, 34 may be supplied to the ED 10, the gateway 20 and the server 30, respectively, on a computer-readable medium, which may be a tangible (non-transitory) product (e.g. magnetic medium, optical disk, read-only memory, flash memory, etc.) or a propagating signal.

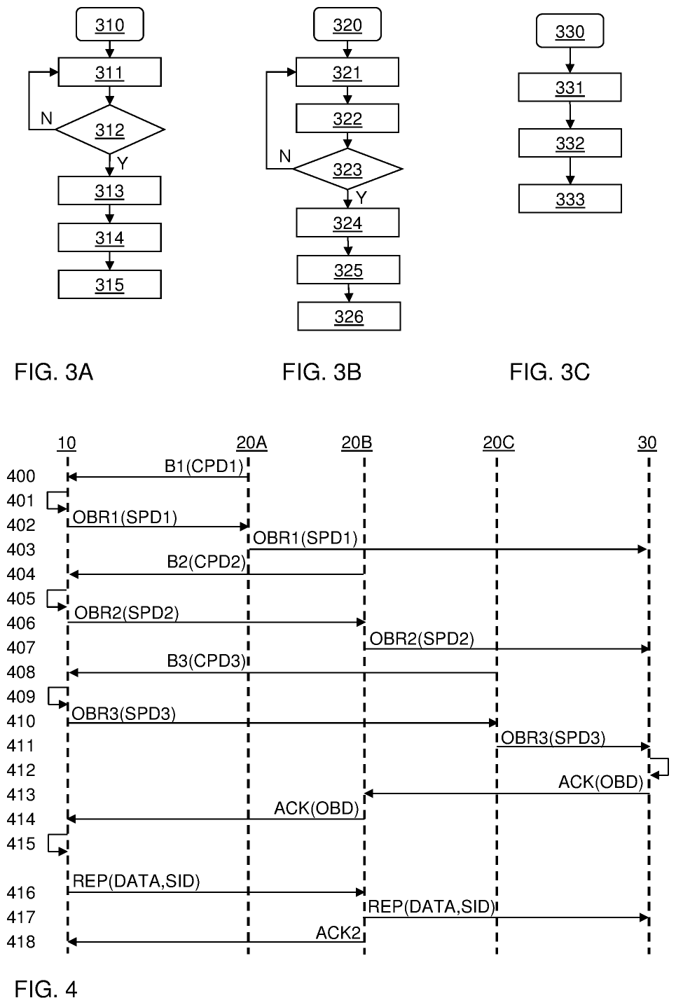

FIG. 3A is a flow chart of a method 310 for onboarding performed by an ED 10 in accordance with an embodiment. The method 310 presumes that the gateways 20A-20C are arranged to perform an onboarding method 320 (FIG. 3B) which involves repeatedly transmitting a beacon containing communication parameter data (denoted CPD in the following), and that the server 30 is arranged to perform an onboarding method 330 (FIG. 3C) that involves receiving and processing onboarding requests (denoted OBR in the following) originating from EDs 10.

The method 310 comprises a step 311 of operating the transceiver 16 (FIG. 2A) to receive signals at an association frequency defined by the static definition data, and a step 312 of monitoring the transceiver 16 for receipt of the above-mentioned beacon. If no beacon is received by step 312, the method returns to step 311. When step 312 receives a beacon, the method proceeds to step 313, which extracts CPD from the beacon. Step 314 then configures the transceiver 16 in accordance with CPD, and step 315 operates the transceiver 16 to transmit an OBR for the server 30 in the network 40.

It may be noted that if the ED 10 is within range of multiple gateways that operate at the same association frequency, the OBR of step 315 will be received by the multiple gateways and processed in accordance with the method 320 (below).

It is conceivable that steps 311-312 are repeated to sequentially scan plural association frequencies defined by the static definition data. Thereby, multiple gateways within range of the ED 10 and operating at different association frequencies may receive an OBR from the ED 10 as a result of step 315.

It is further conceivable that the method 310 repeats steps 311-312 until the ED 10 is finally onboarded, and that each beacon that is received by step 312 is processed in accordance with steps 313-315. This means that the respective gateway within range of the ED 10 may receive plural OBRs from the ED 10.

Turning now to the method 320 in FIG. 2B, which is performed by the respective gateway 20A-20C in the system 1 (FIG. 1), step 321 operates the radio circuit 26A (FIG. 2B) at a predefined association frequency to transmit a beacon comprising the CPD for the gateway. The CPD includes a predefined communication frequency and may also define a related output power level, modulation, coding, etc. In step 321, the gateway may be in the above-mentioned association mode. It is conceivable that step 321 transmits the beacon at more than one predefined association frequency. Step 322 operates the radio circuit 26A to receive signals at the predefined communication frequency, and step 323 monitors the transceiver 26A for receipt of an OBR from any ED 10 in the system 1. In steps 322-323, the gateway may be in the above-mentioned normal mode. It is conceivable that step 322 operates to receive signals at plural communication frequencies (which may be included in the CPD). If no OBR is received by step 323, the method returns to step 321. When step 323 receives an OBR, the method proceeds to step 324, which operates the communication circuit 26B to transmit the OBR to the server 30 on the network 40. If the gateway receives an acknowledgement message (denoted ACK in the following) from the server 30 on the communication circuit 26B (step 325), the gateway operates (step 326) its radio transceiver 26A at the predefined communication frequency to transmit the ACK for receipt by the specific ED 10 that transmitted the OBR received in step 323.

Turning now to the method 330 in FIG. 2C, which is performed by the server 30 in the system 1 (FIG. 1), step 331 receives, by the communication device 36 (FIG. 2C), OBRs from the gateways located within range of the ED 10. Step 332 appoints, among these gateways, a designated or selected gateway to be associated with the ED 10. Step 332 may involve applying a predefined logic, e.g. comprising a set of rules and/or policies, to select the gateway to be appointed for the respective ED. The predefined logic may be configured for a single objective or to achieve a balance of different objectives. The objective(s) may, e.g., include balancing the load on the gateways in the system, achieving a high data throughput, minimizing data loss, etc. By the predefined logic, it is conceivable that the logical network topography of the system 1 differs from its physical network topology. The predefined logic may operate, at least in part, on a set of signal parameter values (denoted SPD in the following) included in the OBRs. The SPD may be set and included in the respective OBR by the originating ED 10 and/or by the gateway that forwards the OBR to the server 30. For example, SPD may represent a measured signal quality between the originating ED and the forwarding gateway and/or between the forwarding gateway and the server. Examples include a signal strength of the wireless connection between the ED and the gateway, a signal-to-noise ratio, a delay time, a data loss indicator or a data error rate in the communication between the ED and the gateway or between the gateway and the server. In step 333, the server 30 transmits, by the communication device 36, ACK to the selected/appointed gateway, which thereby is caused to operate in accordance with steps 325-326 as described above.

It may be noted that the server 30 in step 332 may alternatively decide not to onboard the ED 10. For example, the server 30 may determine that the ED 10 is misconfigured or that it is in an incorrect location, e.g. given by the locations of the gateways 20A-20C.

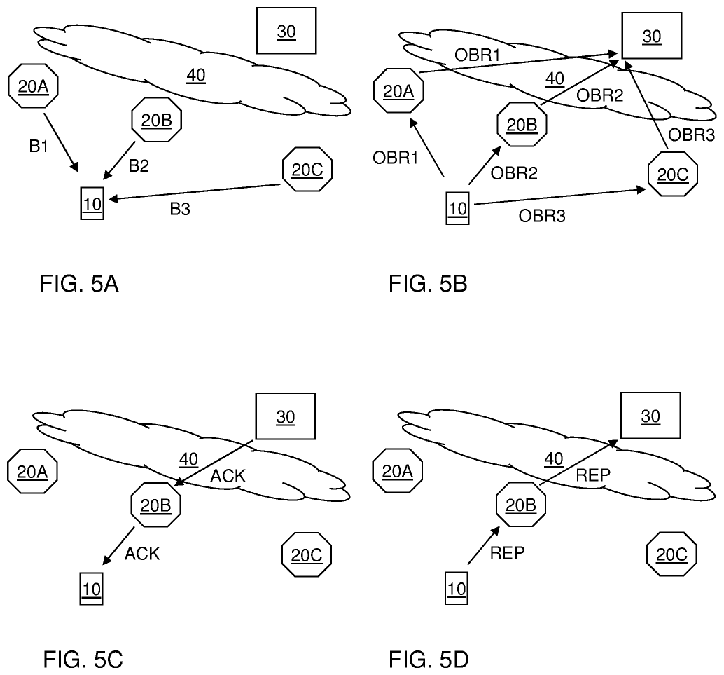

An example of the system-wide procedure for onboarding ED 10 in FIG. 1 will now be descried with reference to a sequence diagram in FIG. 4 and data transmission graphs in FIGS. 5A-5C. As illustrated in FIG. 5A, gateways 20A, 20B, 20C repeatedly transmits, on a respective association frequency, a respective beacon B1, B2, B3. The respective beacon contains communication parameter data CPD1, CPD2, CPD3 (steps 400, 404, 408) and a gateway ID of the originating gateway 20A, 20B, 20C, e.g. a predefined device address. The ED 10 intercepts beacon B1 (step 400), extracts CPD1 and configures the transceiver 16 accordingly (step 401), and transmits an onboarding request OBR1 containing the above-mentioned signal parameter value(s) SPD1 and a device ID of the ED 10, e.g., a predefined device address (step 402). As illustrated in FIG. 5B, gateway 20A intercepts OBR1, and forwards OBR1 together with its gateway ID to the server 30 (step 403). Similarly, the ED 10 intercepts beacon B2 (step 404), extracts CPD2 and configures the transceiver 16 accordingly (step 405), and transmits an onboarding request OBR2 containing signal parameter value(s) SPD2 and the device ID (step 406). As illustrated in FIG. 5B, gateway 20B intercepts and forwards OBR2 together with its gateway ID to the server 30 (step 407). Similarly, the ED 10 intercepts beacon B3 (step 408), extracts CPD3 and configures the transceiver 16 accordingly (step 409), and transmits an onboarding request OBR3 containing signal parameter value(s) SPD3 and the device ID (step 410). As illustrated in FIG. 5B, gateway 20C intercepts and forwards OBR3 together with its gateway ID to the server 30 (step 411). Based on device ID, the server 30 collates the incoming onboarding requests OBR1, OBR2, OBR3 and evaluates them in relation to the above-mentioned predefined logic and, in the illustrated example, appoints gateway 20B as the selected gateway to communicate with the ED 10 (step 412). The server 30 transmits ACK and device ID to the selected gateway 20B (step 413). The ACK is transmitted as a confirmation that the ED 10 has been onboarded by the server 30. As illustrated in FIG. 5C, gateway 20B receives ACK and operates its radio transceiver 26A to transmit ACK at the predefined communication frequency (step 414). Gateway 20B also adds the ED 10 to a list of assigned EDs 10 at the gateway 20B. The ED 10 monitors the communication frequencies of the gateways 20A, 20B, 20C (given by CPD1, CPD2, CPD3) and intercepts ACK from gateway 20B (step 414). After receiving ACK and determining that ACK contains the correct device ID, the ED 10 terminates the initial discovery procedure (step 415). As indicated in FIG. 4, ACK may contain onboarding data (denoted OBD in the following). The OBD is set by the server 30 in step 412 and may enable the ED 10 to operate in the system 1. For example, OBD may comprise one or more of a unique network identity for the ED 10, a definition of power setting for the ED 10, a schedule for transmitting heartbeats to the server 30, and a definition of sensor data to be reported to the server 30, etc. Although OBD is shown to be included in ACK, the server 30 may alternatively transmit OBD to the gateway separately from ACK, whereupon the gateway may transmit OBD in a step similar to step 414. Upon receipt of the OBD, the ED 10 may apply the OBD when transmitting sensor data to the server 30. In the example of FIG. 4, the OBD contains a unique sensor ID, SID, set by the server 30, and the ED 10 includes SID in subsequent reporting messages, REP, containing the sensor data. Thus, when onboarded, the ED 10 operates its radio transceiver 26A to transmit REP at the communication frequency of gateway 20B (step 416). The gateway 20B, when operating the transceiver 26A at the predefined communication frequency, intercepts REP and detects that it originates from one of its appointed EDs. As illustrated in FIG. 5D, gateway 20B then forwards REP to the server 30, which may store and/or process the sensor data (step 417). The gateway 20B also transmits an acknowledgement message ACK2 for receipt by the ED 10 (step 418). The gateway 20B may be preconfigured to transmit ACK2 in response to each REP. Alternatively, a setting in OBD may instruct the gateway 20B to transmit ACK2 in response to each REP. Thus, the server 30 may control the operation of the respective gateway 20B by way of settings in the OBD. In a further alternative, the gateway 20B is configured (by the server 30 or preconfigured) to transmit ACK2 only upon receipt on a corresponding acknowledgement message from the server 30.

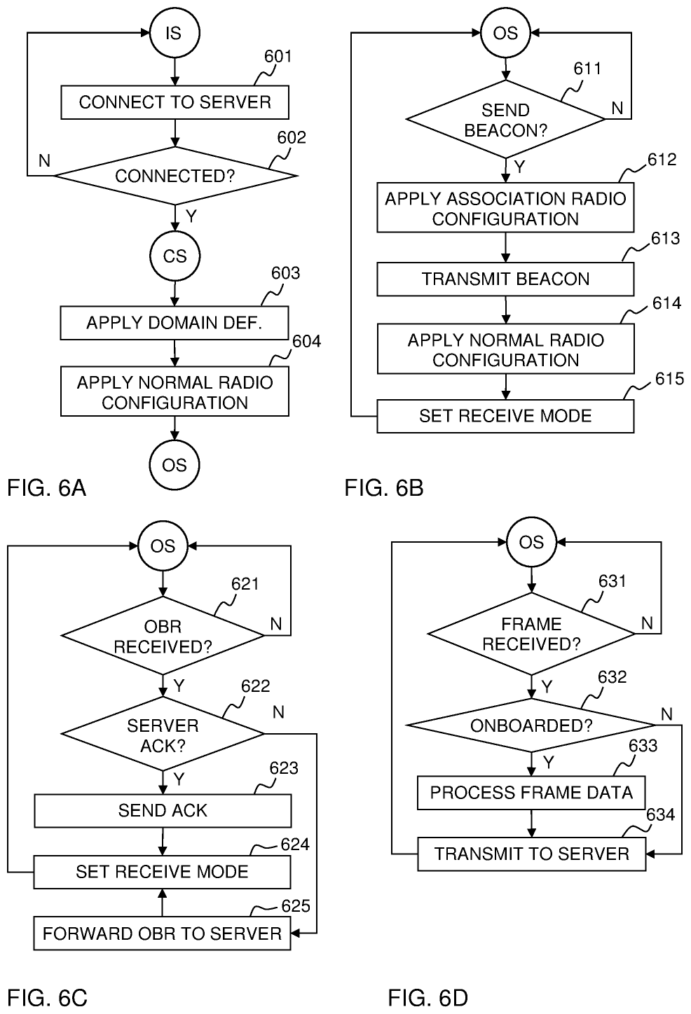

FIGS. 6A-6D are flow charts of processes performed in a gateway in accordance with embodiments.

FIG. 6A exemplifies an initiation process when the gateway is in an initial state, IS. In step 601, the gateway tries to connect to the server 30. When the gateway is connected (step 602), the gateway enters a connected state, CS. In the connected state, the gateway may communicate with the server to receive a regulatory domain definition and radio configuration data which comprises an association radio configuration for the association mode including the one or more association frequencies, and a normal radio configuration including the one or more communication frequencies. Alternatively, the regulatory domain definition and/or the radio configurations may be pre-stored in the gateway. The gateway applies the regulatory domain definition (step 603) and the normal radio configuration (step 604) and thereby enters an operational state, OS, in which it is the normal mode and operable to perform any of the processes in FIGS. 6B-6D.

FIG. 6B exemplifies a beaconing process, which may be performed in the operational state, OS. The gateway monitors (step 611) a condition for beaconing, e.g. in relation to a time interval or another event, e.g. a trigger event from the server 30, and proceeds to apply (step 612) the association radio configuration if the condition is fulfilled. The gateway then transmits a beacon containing CPD (step 613) and proceeds to apply the normal radio configuration (step 614) and to set the transceiver 16 in receive mode (step 615).

FIG. 6C illustrates a confirmation process which may be performed in the operational state, OS. The gateway monitors (step 621) the transceiver 26A for receipt of an OBR. If an OBR is received, the gateway checks (step 622) if it has received an ACK from the server 30 for the originating ED. If the ACK has been received and the ED has thus been onboarded by the server 30, the gateway transmits an ACK to the ED (step 623) and then sets the transceiver 16 in receive mode (step 624). If the ACK has not been received from the server 30, the gateway forwards the OBR to the server 30 (step 625) and then sets the transceiver 16 in receive mode (step 624). In this embodiment, the gateway will forward all incoming OBRs from an ED 10 to the server 30 as long as the server 30 has not acknowledged to the gateway that the particular ED 10 has been onboarded (cf. step 325 in FIG. 3B and step 413 in FIG. 4). Further, in this embodiment, the gateway will transmit the ACK (cf. step 326 in FIG. 3B and step 414 in FIG. 4) to the ED only in response to an incoming OBR from the ED. This enables power saving in the ED, which only needs to be active in receive mode during a short period following transmission of an OBR.

FIG. 6D illustrates a generic frame receiving process, which may include the confirmation process of FIG. 6C. The gateway monitors (step 631) the transceiver 26A for receipt of a frame, which may be an OBR, a heartbeat, a REP, or any other type of data packet or message. If a frame is received, the gateway checks (step 632) if the frame originates from an onboarded ED, e.g. if the originating ED is included in the list of assigned EDs 10 at the gateway. If the frame originates from an onboarded ED, the gateway performs a dedicated processing (step 633), e.g. of the frame or data contained in the frame, and then transmits (step 634) a notification to the server 30, where the notification may include the frame, the data, processed data or another item, such as an acknowledgement. If the frame does not originate from an onboarded ED, the gateway transmits (624) the frame to the server 30.

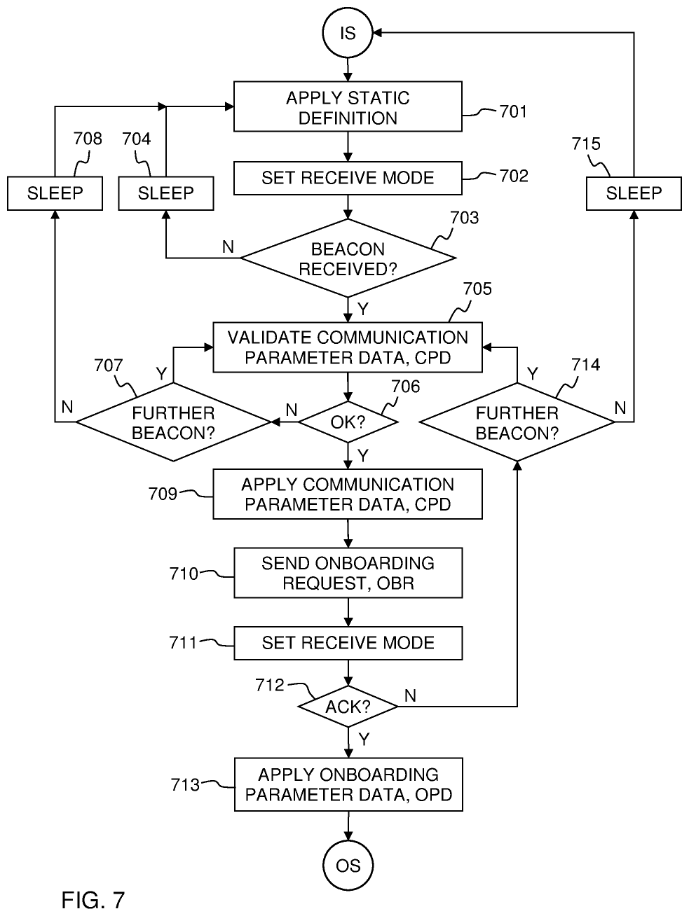

FIG. 7 is a flow chart of an initiation process performed in an ED 10 in accordance with an embodiment. At the start of the initiation process, the ED is in an initial state, IS. The ED selects an association frequency from the static frequency definition, which is prestored in memory and may define all available association frequencies in the system 1. The ED then applies the selected association frequency to the transceiver 16 (step 701), sets the transceiver 16 in receive mode (step 702) and monitors the transceiver 16 for receipt of one or more beacons (step 703). If no beacon is received, the process returns to step 701, which may select another association frequency from the static frequency definition. As indicated in FIG. 7, the process may include a sleep mechanism 704 that controls the repetition rate of steps 701-703. If step 703 receives at least one beacon, the process compiles a list of beacons and sequentially processes each beacon on the list by steps 705-710. In the illustrated example, the process proceeds to validate the CPD that is included in the beacon (step 705). The validation, which is an optional feature, may involve checking that the CPD is compliant with at least one domain definition that may be prestored in the memory. The validation fails (step 706), the process evaluates if there is a further beacon on the list of beacons (step 707). If so, the process proceeds to the validation step 705. Otherwise, the process returns to step 701, optionally via a sleep mechanism 708. If the validation succeeds (step 706), the process proceeds to apply the CPD to the transceiver 16 (step 709), operate the transceiver 16 to transmit an OBR (step 710), and set the transceiver 16 in receive mode (step 711). If an ACK designating the ED is received (step 712) within a waiting time, which may be predefined, the process proceeds to extract the OBD from the ACK and apply the OBD (step 713) and the ED is in an operational state, OS. If the ACK is not received in step 712, the process evaluates if there is a further beacon on the list of beacons (step 714). If so, the process proceeds to the validation step 705. Otherwise, the process returns to the initial state, optionally via a sleep mechanism 715.

In the following, a set of items are recited to summarize some aspects and embodiments as disclosed in the foregoing.

Item 1: An electronic device comprising a transceiver (16) for wireless communication and being configured to: operate the transceiver (16) at one or more predefined association frequencies for receipt of a node beacon from a network node (20A; 20B; 20C) among a plurality of network nodes that are connected in a network (40) to a server (30), wherein the node beacon comprises communication parameter data (CPD) for wireless communication with at least the network node (20A; 20B; 20C) among the plurality of network nodes; and upon receipt of the node beacon, extract the communication parameter data (CPD) from the node beacon, configure the transceiver (16) in accordance with the communication parameter data (CPD), and operate the transceiver (16) to transmit an onboarding request (OBR) for the server (30) in the network (40).

Item 2: The electronic device of item 1, wherein the onboarding request (OBR) is configured to, upon receipt by one or more network nodes (20A; 20B; 20C) among the plurality of network nodes, cause the one or more network nodes (20A; 20B; 20C) to transmit the onboarding request (OBR) to the server (30).

Item 3: The electronic device of item 1 or 2, which is further configured to: operate the transceiver (16), configured in accordance with the communication parameter data (CPD), to receive an acknowledgement message (ACK) confirming that the electronic device (10) is onboarded on the network (40).

Item 4: The electronic device of item 3, wherein the acknowledgement message (ACK) is received from a designated network node (20A; 20B; 20C) among the plurality of network nodes, the designated network node (20A; 20B; 20C) being designated among the plurality of network nodes by the server (40).

Item 5: The electronic device of item 4, which is further configured to, after receiving the acknowledgement message (ACK), configure the transceiver (16) to communicate with the server (30) through the designated network node (20A; 20B; 20C).

Item 6: The electronic device of item 5, which is further configured to: operate the transceiver (16), configured in accordance with the communication parameter data (CPD), to receive onboarding data (OBD), and apply the onboarding data (OBD) when communicating with the server (30) through the designated network node (20A; 20B; 20C).

Item 7: The electronic device of item 6, wherein the onboarding data (OBD) originates from the server (30).

Item 8: The electronic device of item 6 or 7, wherein the onboarding data (OBD) comprises one or more of an identifier (SID) of the electronic device (10) in the network (40), a definition of power setting for the electronic device (10), a schedule for transmitting data to the server (30), and a definition of data to be reported to the server (30).

Item 9: The electronic device of any preceding item, wherein the communication parameter data (CPD) comprises at least one communication frequency of the network node (20A; 20B; 20C).

Item 10: The electronic device of item 9, which is further configured to validate the at least one communication frequency against a predefined set of allowable communication frequencies.

Item 11: The electronic device of any preceding item, which is further configured to: measure one or more signal parameter values for the wireless communication with the network node (20A; 20B; 20C), and include the one or more signal parameter values in the onboarding request (OBR).

Item 12: The electronic device of item 11, wherein the one or more signal parameter values represents one or more of a signal-to-noise ratio, a signal strength, a delay time, a data loss indicator and a data error rate.

Item 13: The electronic device of any preceding item, which is configured to operate the transceiver (16) at a sequence of predefined association frequencies for receipt of the node beacon.

Item 14: The electronic device of any preceding item, which is further configured to, when onboarded on the network (40), obtain sensor data from one or more sensors (17) and transmit the sensor data to the server (30) on the network (40).

Item 15: A method for network onboarding in an electronic device (10) comprising a transceiver (16) for wireless communication, said method comprising: operating (311) the transceiver (16) at one or more predefined association frequencies for receipt of a node beacon from a network node (20A; 20B; 20C) among a plurality of network nodes that are connected in a network (40) to a server (30), wherein the node beacon comprises communication parameter data (CPD) for wireless communication with at least the network node (20A; 20B; 20C) among the plurality of network nodes; and upon receipt (312) of the node beacon, extracting (313) the communication parameter data (CPD) from the node beacon, configuring (314) the transceiver (16) in accordance with the communication parameter data (CPD), and operating (315) the transceiver (16) to transmit an onboarding request (OBR) for the server (30) in the network (40).

Item 16: The method of item 15, wherein the onboarding request (OBR) is configured to, upon receipt by one or more network nodes (20A; 20B; 20C) among the plurality of network nodes, cause the one or more network nodes (20A; 20B; 20C) to transmit the onboarding request (OBR) to the server (30).

Item 17: The method of item 15 or 16, further comprising: operating (414) the transceiver (16), configured in accordance with the communication parameter data (CPD), to receive an acknowledgement message (ACK) confirming that the electronic device (10) is onboarded on the network (40).

Item 18: The method of item 17, wherein the acknowledgement message (ACK) is received from a designated network node (20A; 20B; 20C) among the plurality of network nodes, the designated network node (20A; 20B; 20C) being designated among the plurality of network nodes by the server (40).

Item 19: The method of item 18, further comprising: after receiving the acknowledgement message (ACK), configuring (415) the transceiver (16) to communicate with the server (30) through the designated network node (20A; 20B; 20C).

Item 20: The method of item 19, further comprising: operating (414) the transceiver (16), configured in accordance with the communication parameter data (CPD), to receive onboarding data (OBD), and applying (415) the onboarding data (OBD) when communicating with the server (30) through the designated network node (20A; 20B; 20C).

Item 21: The method of item 20, wherein the onboarding data (OBD) originates from the server (30).

Item 22: The method of items 20 or 21, wherein the onboarding data (OBD) comprises one or more of an identifier (SID) of the electronic device (10) in the network (40), a definition of power setting for the electronic device (10), a schedule for transmitting data to the server (30), and a definition of data to be reported to the server (30).

Item 23: The method of any one of items 15-22, wherein the communication parameter data (CPD) comprises at least one communication frequency of the network node (20A; 20B; 20C).

Item 24: The method of item 23, further comprising: validating (705) the at least one communication frequency against a predefined set of allowable communication frequencies.

Item 25: The method of any one of items 15-24, further comprising: measuring one or more signal parameter values for the wireless communication with the network node (20A; 20B; 20C), and including the one or more signal parameter values in the onboarding request (OBR).

Item 26: The method of item 25, wherein the one or more signal parameter values represents one or more of a signal-to-noise ratio, a signal strength, a delay time, a data loss indicator and a data error rate.

Item 27: The method of any one of items 15-26, wherein the transceiver (16) is operated at a sequence of predefined association frequencies for receipt of the node beacon.

Item 28: A network node comprising a first transceiver (26A) for wireless communication with electronic devices (10) and a second transceiver (26B) for communication with a server (30) over a network (40), said network node being configured to: operate the first transceiver (26A) at a predefined association frequency to transmit a beacon comprising communication parameter data (CPD) for wireless communication with at least the network node (20A; 20B; 20C) among a plurality of network nodes; operate the first transceiver (26), configured in accordance with the communication parameter data (CPD), to receive an onboarding request (OBR) for the server (30) in the network (40) from an electronic device (10); upon receipt of the onboarding request (OBR), operate the second transceiver (26B) to transmit the onboarding request (OBR) to the server (30); operate the second transceiver (26B) to receive an acknowledgement message (ACK) from the server (30) confirming that the electronic device (10) is onboarded; and operate the first transceiver (26A), configured in accordance with the communication parameter data (CPD), to transmit the acknowledgement message (ACK) or part thereof for receipt by the electronic device (10).

Item 29: The network node of item 28, wherein the first transceiver (26A) is operated at a communication frequency included in the communication parameter data (CPD) to receive the onboarding request (OBR).

Item 30: The network node of item 28 or 29, wherein the second transceiver (26B) is operated to receive onboarding data (OBD) from the server (30), and the first transceiver (26A) is operated to transmit the onboarding data (OBD) for receipt by the electronic device (10).

Item 31: A method for network onboarding in a network node (20A; 20B; 20C) comprising a first transceiver (26A) for wireless communication with electronic devices (10) and a second transceiver (26B) for communication with a server (30) over a network (40), said method comprising: operating (321) the first transceiver (26A) at a predefined association frequency to transmit a beacon comprising communication parameter data (CPD) for wireless communication with at least the network node (20A; 20B; 20C) among a plurality of network nodes, said communication parameter data (CPD) comprising a communication frequency; operating (322) the first transceiver (26), configured in accordance with the communication parameter data (CPD), to receive an onboarding request (OBR) for the server (30) in the network (40) from an electronic device (10); upon receipt (323) of the onboarding request (OBR), operating (324) the second transceiver (26B) to transmit the onboarding request (OBR) to the server (30); operating (325) the second transceiver (26B) to receive an acknowledgement message (ACK) from the server (30) confirming that the electronic device (10) is onboarded; and operating the first transceiver (26A), configured in accordance with the communication parameter data (CPD), to transmit the acknowledgement message (ACK) or part thereof for receipt by the electronic device (10).

Item 32: The method of item 31, wherein the first transceiver (26A) is operated at a communication frequency included in the communication parameter data (CPD) to receive the onboarding request (OBR).

Item 33: The method of item 31 or 32, wherein the second transceiver (26B) is operated to receive onboarding data (OBD) from the server (30), and the first transceiver (26A) is operated to transmit the onboarding data (OBD) for receipt by the electronic device (10).

Item 34: A server comprising a communication device (36) for communication with a plurality of network nodes (20A, 20B, 20C) on a network (30), said server being configured to: receive, by the communication device (36), an onboarding request (OBR) from one or more network nodes among the plurality of network nodes, the onboarding request (OBR) originating from an electronic device (10) in wireless communication with the one or more network nodes; appoint a designated network node (20A; 20B; 20C) among the one or more network nodes; and transmit, by the communication device (36), an acknowledgement message (ACK) to the designated network node (20A; 20B; 20C) to confirm that the electronic device (10) is onboarded on the network (40) for communication with the server (30) via the designated network node (20A; 20B; 20C).

Item 35: The server of item 34, which is further configured to cause the designated network node (20A; 20B; 20C) to transmit the acknowledgement message (ACK) or part thereof to the electronic device (10).

Item 36: The server of item 34 or 35, which is further configured to assign onboarding data (OBD) for the electronic device (10) and transmit the onboarding data (OBD) to the designated network node (20A; 20B; 20C).

Item 37: The server of item 36, which is further configured to cause the designated network node (20A; 20B; 20C) to transmit the onboarding data (OBD) to the electronic device (10).

Item 38: The server of any one of items 34-36, which is configured to appoint the designated network node (20A; 20B; 20C) by use of signal parameter values included in the onboarding request (OBR).

Item 39: A method for network onboarding in a server (30) comprising a communication device (36) for communication with a plurality of network nodes (20A, 20B, 20C) in a network (30), said method comprising: receiving (331), by the communication device (36), an onboarding request (OBR) from one or more network nodes among the plurality of network nodes, the onboarding request (OBR) originating from an electronic device (10) in wireless communication with the one or more network nodes; appointing (332) a designated network node (20A; 20B; 20C) among the one or more network nodes; and transmitting (333), by the communication device (36), an acknowledgement message (ACK) to the designated network node (20A; 20B; 20C) to confirm that the electronic device (10) is onboarded on the network (40) for communication with the server (30) via the designated network node (20A; 20B; 20C).

Item 40: The method of item 39, which is further configured to cause the designated network node (20A; 20B; 20C) to transmit the acknowledgement message (ACK) or part thereof to the electronic device (10).

Item 41: The method of item 39 or 40, further comprising: assigning (412) onboarding data (OBD) for the electronic device (10) and transmitting (413) the onboarding data (OBD) to the designated network node (20A; 20B; 20C).

Item 42: The method of item 41, further comprising: causing the designated network node (20A; 20B; 20C) to transmit the onboarding data (OBD) to the electronic device (10).

Item 43: The method of any one of items 39-42, wherein the designated network node (20A; 20B; 20C) is appointed by use of signal parameter values included in the onboarding request (OBR).

Item 44: A computer readable-medium comprising computer instructions (14; 24; 34) which, when executed by a processor (12; 22; 32), cause the processor (12; 22; 32) to perform the method in accordance with any one of items 15-27, 31-33 and 39-43.

1. An electronic device comprising a transceiver for wireless communication and being configured to:
operate the transceiver at one or more predefined association frequencies for receipt of a node beacon from a network node among a plurality of network nodes that are connected in a network to a server, wherein the node beacon comprises communication parameter data for wireless communication with at least the network node among the plurality of network nodes; and
upon receipt of the node beacon, extract the communication parameter data from the node beacon, configure the transceiver in accordance with the communication parameter data, and operate the transceiver to transmit an onboarding request for the server in the network, wherein the onboarding request is configured to, upon receipt by one or more network nodes among the plurality of network nodes, cause the one or more network nodes to transmit the onboarding request to the server.

2. The electronic device of claim 1, which is further configured to: operate the transceiver, configured in accordance with the communication parameter data, to receive an acknowledgement message confirming that the electronic device is onboarded on the network.

3. The electronic device of claim 2, wherein the acknowledgement message is received from a designated network node among the plurality of network nodes, the designated network node being designated among the plurality of network nodes by the server.

4. The electronic device of claim 3, which is further configured to, after receiving the acknowledgement message, configure the transceiver to communicate with the server through the designated network node.

5. The electronic device of claim 4, which is further configured to: operate the transceiver, configured in accordance with the communication parameter data, to receive onboarding data, and apply the onboarding data when communicating with the server through the designated network node.

6. The electronic device of claim 5, wherein the onboarding data originates from the server.

7. The electronic device of claim 5, wherein the onboarding data comprises one or more of an identifier of the electronic device in the network, a definition of power setting for the electronic device, a schedule for transmitting data to the server, and a definition of data to be reported to the server.

8. The electronic device of claim 1, wherein the communication parameter data comprises at least one communication frequency of the network node.

9. The electronic device of claim 8, which is further configured to validate the at least one communication frequency against a predefined set of allowable communication frequencies.

10. The electronic device of claim 1, which is further configured to: measure one or more signal parameter values for the wireless communication with the network node, and include the one or more signal parameter values in the onboarding request.

11. The electronic device of claim 10, wherein the one or more signal parameter values represents one or more of a signal-to-noise ratio, a signal strength, a delay time, a data loss indicator and a data error rate.

12. The electronic device of claim 1, which is further configured to, when onboarded on the network, obtain sensor data from one or more sensors and transmit the sensor data to the server on the network.

13. A network node comprising a first transceiver for wireless communication with electronic devices and a second transceiver for communication with a server over a network, said network node being configured to:
operate the first transceiver at a predefined association frequency to transmit a beacon comprising communication parameter data for wireless communication with at least the network node among a plurality of network nodes;
operate the first transceiver, configured in accordance with the communication parameter data, to receive an onboarding request for the server in the network from an electronic device;
upon receipt of the onboarding request, operate the second transceiver to transmit the onboarding request to the server;
operate the second transceiver to receive an acknowledgement message from the server confirming that the electronic device is onboarded; and
operate the first transceiver, configured in accordance with the communication parameter data, to transmit the acknowledgement message or part thereof for receipt by the electronic device.

14. The network node of claim 13, wherein the first transceiver is operated at a communication frequency included in the communication parameter data to receive the onboarding request.

15. The network node of claim 13, wherein the second transceiver is operated to receive onboarding data from the server, and the first transceiver is operated to transmit the onboarding data for receipt by the electronic device.

16. A server comprising a communication device for communication with a plurality of network nodes over a network, said server being configured to:
receive, by the communication device, an onboarding request from one or more network nodes among the plurality of network nodes, the onboarding request originating from an electronic device in wireless communication with the one or more network nodes;
appoint a designated network node among the one or more network nodes; and
transmit, by the communication device, an acknowledgement message to the designated network node to confirm that the electronic device is onboarded on the network for communication with the server via the designated network node, wherein the onboarding request is configured to, upon receipt by one or more network nodes among the plurality of network nodes, cause the one or more network nodes to transmit the onboarding request to the server.

17. The server of claim 16, which is further configured to cause the designated network node to transmit the acknowledgement message or part thereof to the electronic device.

18. The server of claim 16, which is further configured to assign onboarding data for the electronic device and transmit the onboarding data to the designated network node.

19. The server of claim 18, which is further configured to cause the designated network node to transmit the onboarding data to the electronic device.

20. The server of claim 16, which is configured to appoint the designated network node by use of signal parameter values included in the onboarding request.
